(19) United States
(12) Patent Application Publication
(10) Pub. No.: US 2011/0145037 A1
(43) Pub. Date: Jun. 16, 2011

(54) Document management method and apparatus to process a workflow task by parallel or serially processing subtasks thereof

(75) Inventors: Michael Domashchenko, Liburn, GA (US); Igor Poluektov, Roswell, GA (US); Vladimir Manetin, Alpharetta, GA (US); Phillip K. Hargrove, Olathe, KS (US)

(73) Assignee: VERTAFORE, INC.

(21) Appl. No.: 12/654,276

(22) Filed: Dec. 16, 2009

(51) Int. Cl. G06Q 10/00

(52) U.S. Cl. 705/7.27

(57) ABSTRACT

A method to facilitate workflow processing in a business enterprise comprising identifying a principal task in a workflow process; splitting the principal task into two or more subtasks according actual practices of the business enterprise wherein the splitting includes determining which subtasks are to be created, which are to be parallel-processed and which are to be serially-processed; naming the subtasks; specifying an order of completion of the subtasks, i.e., parallel-processed or serially-processed; assigning the subtasks to one or more users for processing; notifying the users of subtask assignment; providing an indication of status of completion of the subtasks; reporting completion of the subtasks to the task manager; optionally altering or modifying the preceding steps; completing the principal task according to results of the subtasks; enabling a user to check status of subtasks; and releasing the principal task in a workflow of other tasks. A corresponding system is also disclosed.

### BACKGROUND

This invention relates to a workflow processing system and method implemented in a document management system, but more specifically, to a method and a system to enable dynamic processing and management of a task during workflow processing of documents.

In order to streamline or make business operations more efficient many enterprise organizations, such as a banking or insurance company, utilize automated workflow management (WM) systems to process documents or other information. In the past, such automated management has been static meaning, once defined, the process proceeded along a predetermined route. Very often, though, circumstances changed during routine processing but the need for change could not be reflected in the predetermined automated workflow process.

In addition, success of such systems greatly depended on how closely automated tasks tracked actual business practices employed by the organization. As part of the overall workflow task, knowledge and skills of an experienced workflow administrator were typically applied to determine how the automated tasks are to be mapped or aligned with actual business practices. A workflow management system or method failing to track the deployed business model may also degrade the company's overall performance.

According to a principal aspect of the present invention, a method or system is deployed in a document management system to allow a workflow administrator or task manager to dynamically interact with an automated system during workflow processing in order to identify and define a number subtasks of a principal workflow task; to determine a manner and/or order of subtask processing, e.g., in parallel or seriatim; to assign the subtasks to various users of the organization; to assemble or combine results of the subtasks in order to complete and release the principal workflow task for further processing; and optionally, to alter any one of these and other necessary or desired steps during workflow processing of documents. Interaction may occur in real time to dynamically alter, update, or change the automated workflow processing of tasks.

As indicated above, present day automated workflow management systems and methods are generally static, that is, once defined, they cannot be altered in real time to accommodate changes in circumstances that often occurs in real-life business situations. Thus, they do not offer the flexibility or an efficient way of dynamically defining, distributing, and managing subtasks among multiple users according to unique and often changing aspects of a business enterprise.

### SUMMARY

A first aspect of the invention comprises an improvement in a file management system having user processing points at multiple locations of a communication network of a business enterprise. The improvement comprises a method of dynamically automating workflow operations via interaction between a task manager and the file management system and comprises the steps of identifying via a graphical interface a principal task in the workflow operations of the enterprise, enabling the task manager to split the principal task into two or more subtasks according to knowledge of the workflow operations, enabling the task manager to provide names for the subtasks, specifying an order of completion of the subtasks according to an interrelation therebetween, and according to provided names, assigning the subtasks to one or more users in the business enterprise; sending over the network notification to the users of subtask assignment; enabling the users to denote completion of an assigned subtask and monitoring status of completion thereof; providing upon inquiry an indication of the status of completion; denoting completion of the principal task upon completion of desired subtasks thereof; and optionally or if necessary, altering, changing or modifying any one or more of the preceding steps during workflow operations. These steps may be performed in real time even after the automated process has been initially defined by the task manager.

Additional aspects of the method include the step of enabling the task manager to split the principal task by determining which if any subtasks are to be created according to knowledge of the business enterprise, and determining which of the created subtasks is to be parallel-processed and which is to be serially-processed according to any interrelation therebetween.

Other aspects of the method include, after the denoting step, releasing the principal task for any further processing in a workflow process of other tasks; automatically reporting to the task manager an indication of completion of the subtasks; and/or designating a user as a task manager to interact with the file management system to process a principal task.

Another aspect of the method comprises a method of facilitating workflow processing in a business enterprise comprising the steps of identifying a principal task in a workflow process; splitting the principal task into two or more subtasks according practices of the business enterprise wherein the splitting includes determining which if any subtasks are to be create, which of the created subtasks are to be parallel-processed, and which are to be serially-processed; naming or selecting from a list names of the subtasks; specifying an order of completion of the subtasks, such as specifying parallel-processing or serially-processing; assigning the subtasks to one or more users for processing; notifying the users of assignment of their subtasks; providing an indication of status of completion of the subtasks; reporting the completion of the subtasks to a task or other manager; completing the principal task according to results of the subtasks such as by merging or combining the results of the subtasks; enabling a user to check status of subtasks; and releasing the principal task in a workflow of any necessary or desired tasks. Again, these steps may be performed on-the-fly, in real time, to provide a dynamic automated task management method.

In addition to providing a system to carry out the methods described herein, another more specific aspect of the invention comprises an improvement in a file management system having user workstations communicating over a network to automate workflow operations of a business enterprise via interaction between a task manager and the file management system. The improvement comprises a first graphical user interface generated at a workstation to enable the task manager to identify a principal task in the workflow operations of the enterprise, to split the principal task into two or more subtasks according to knowledge of the workflow operations, to provide names for the subtasks, to specify an order of performance of the subtasks according to an interrelation therebetween, and to assign performance of the subtasks to one or more users within the business enterprise; a communication interface of the first graphical user interface to convey a message over the network to notify the users of subtask assignment; a second graphical user interface generated at a second workstation to enable a user to receive notification of the task assignment, to denote completion of an assigned subtask, and to convey a status message indicating progress of completion of a subtask; and a task management module of the file management system to receive any status message from the user, to provide automatically or upon inquiry an indication status of completion of the subtask, and to denote completion of the principal task upon completion of desired subtasks thereof.

A further improvement of the file management system includes, wherein the first user interface enables the task manager to specify a serial order of completion of a subtask when completion thereof depends on completion another subtask and to specify a parallel order of processing when completion of a subtask does not depend on results of another subtask. Another improvement includes wherein the first user interface enables a workflow administrator to delegate a user as a task manager.

### BRIEF DESCRIPTION OF THE DRAWINGS

FIG. 1 is flow diagram of an exemplary method of improving workflow operations in a file management system in accordance with a first aspect of the present invention.

FIG. 2 depicts a block diagram arrangement of a file management system that may incorporate the method of FIG. 1 to improve workflow operations therein.

FIG. 3 conceptually illustrates splitting a principal task into multiple subtasks to be performed by users, and combining results of the subtasks to complete the principal workflow task.

FIG. 4 depicts an exemplary graphical user interface that may be presented to a workflow administrator or task manager in connection with defining or splitting a principal workflow task into multiple subtasks in accordance with an aspect of the present invention, which includes designating various subtask parameters, such as, a requirement to create, a requirement to complete, or stand-alone or dependent status of the subtask, e.g., a serial or parallel-processed subtask.

FIG. 5 depicts an exemplary graphical user interface that may be presented to a user, e.g., an employee of a business enterprise, to identify various work assignments to be completed relative to the subtasks defined by a workflow administrator or task manager.

FIG. 6 shows a status report window that may be viewed to assess the progress of completion the subtasks.

FIG. 7 shows an example of a workflow with split/rendezvous step pair in which the task manager graphically defines an execution path that goes outside of the split/rendezvous pair.

FIG. 8 shows an example of a workflow with split/rendezvous step pair in which the task manager creates a cancellation path as an independent task having its own, completely separate lifecycle outside of the split/rendezvous pair.

FIG. 9 shows a user interface produced by the inventive system to enable the task manager to automatically release the result upon completion of underlying subtasks.

FIG. 10 shows an example of workflow and tasks-related database schema that may be utilized by the inventive systems and methods illustrated herein.

### DESCRIPTION OF ILLUSTRATIVE EMBODIMENTS

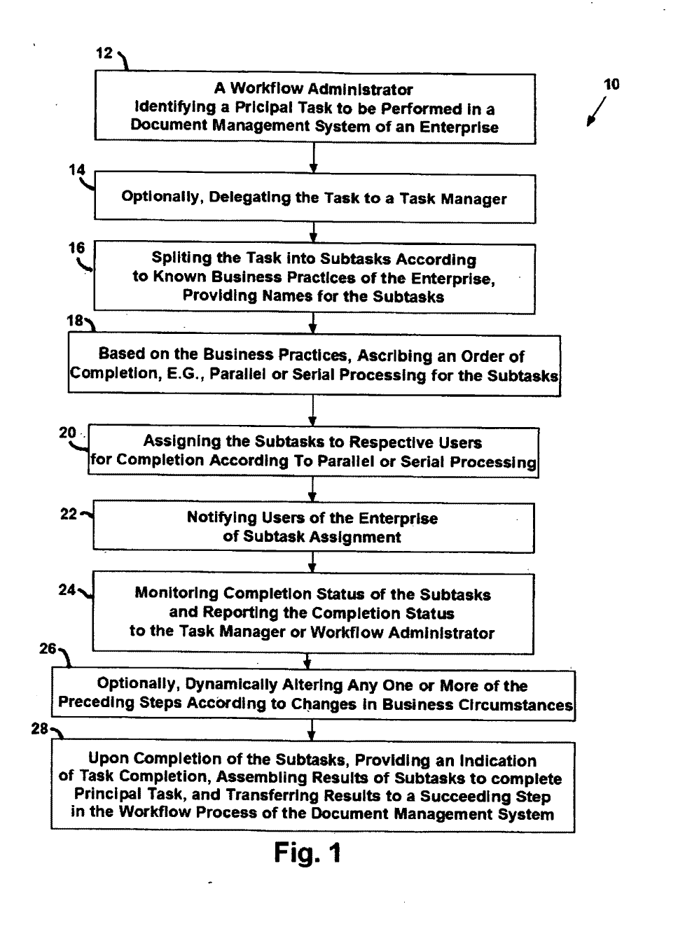

FIG. 1 illustrates an exemplary method 10 of facilitating workflow operations according to an aspect of the present invention where a workflow administrator of a business enterprise at step 12 identifies a principal workflow task to be performed in connection with computerized document or file management or, optionally at step 14, where the administrator delegates part or all of the principal task to a task manager, who may be a user. The delegation step 14 allows the workflow administrator to delegate the decision making steps to a user who, in turn, processes or assigns processing of the subtasks to other users. By reverting to the delegation option, the workflow administrator may simply provide a recommended plan of action to be followed while allowing the user to make decisions based on certain business criteria that may vary from task to task, or from subtask to subtask, according to existing or changing business circumstances. Once the delegation option is set by the administrator, however, the method may provide that such delegation may not be overridden by the user depending on control criteria set by the workflow administrator.

Generally, a principal task may be one of many tasks in an overall workflow process that is routinely performed by the enterprise organization using a computerized file management system where multiple users, e.g., employees of the enterprise, access shared files or work items over a local or remote network in order to perform their respective duties. The task manager may be a user or a workflow administrator. At step 16, the task manager segments or splits the principal task into a number of subtasks according to his or her specialized skills, knowledge, or according to rules or business practices of the enterprise. The task manger also assigns or provides specific names for the created subtasks. At step 18, the task manager determines whether the subtasks are to be processed serially or in parallel. A serial subtask, for example, is designated as such when its processing depends upon results or completion of a preceding task or subtask whereas a parallel task is more or less a stand alone independent task that may not depend on completion of other tasks or subtasks.

At step 20, the task manager assigns the subtasks to various users of the enterprise at will or according to their respective skills or rules of the enterprise and, at step 22, the task manager notifies the respective users of their assignment. Notification of the respective work assignments may occur in a customary way, such as by email or electronic messaging. The method, at step 24, further includes monitoring the status of progress of subtask completion as well as reporting progress and/or completion status. Such reports may be sent over a network to the task manager automatically or made available to the task manager via a query directed to the automated system. Automatic status reporting may occur in a customary way, such as by email or electronic messaging.

At step 26, the task manager may if desired alter, change, or modify any one or more of the preceding steps in real time at any time during workflow processing according to changes in business circumstances of the enterprise or according to any other condition, circumstance, or fact becoming known to the task manager after workflow automation has been defined. Such alteration, change or modification may be accomplished by providing a user interface to enable the task manager to revisit any one of the steps 12 through 24, or at any other time during workflow processing. Upon completion of the subtasks, the method includes at step 28 providing an indication of completion, combining results of the subtasks to render the principal task complete, and/or transferring results of the principal task to any succeeding step in the overall workflow scheme of the file or document management system, such as, when other tasks remain to be subsequently performed.

Any particular item of work of an enterprise, i.e., a principal task, may be split into multiple subtasks and distributed to enable processing by one or more local or distributed or remote users. By introducing the above-mentioned concept into a workflow system or method of a file management system, and providing for dynamic work load distribution and status monitoring and reporting, a business enterprise may shorten the time required to complete a particular task at hand and/or accommodate changes in business circumstances during workflow processing.

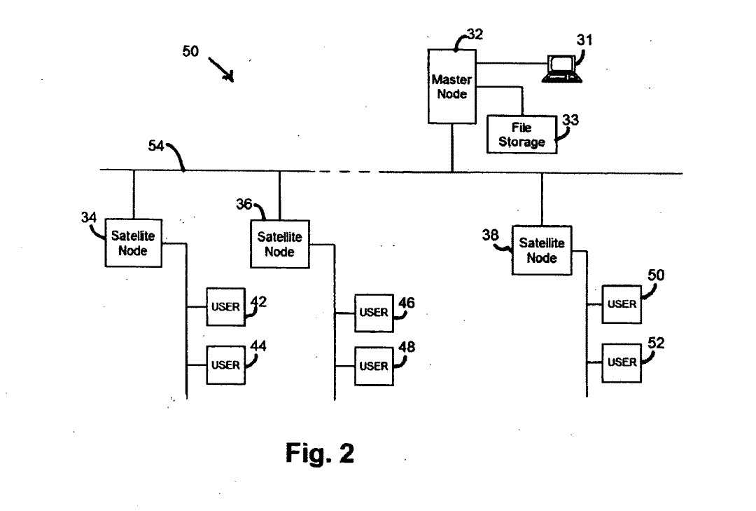

FIG. 2 depicts a block diagram arrangement of an exemplary multi-user file management system 30 in which the present invention may be implemented. System 30 is configured to manage or maintain files or work items to be processed by users. The system includes a master node 32 residing at a central location of the enterprise and one or more satellite nodes 34, 36, and 38 that respectively reside at branch offices of the enterprise. Satellite nodes 34, 36, and 38 serve respective users 42, 44, 46, 48, 50, and 52 of the remote satellite offices where users process files or perform work assignments relative to a file. Each of the nodes 32, 34, 36, and 38 includes data processing devices or servers that manage, store, and/or effect transfer of files and other information locally or remotely via a network 54, as well as a user interface (e.g., display, keyboard, mouse, etc.) to enable a user to communication with the system. These nodes also generate graphical user interfaces on a display screen, subsequently described, that enable the users to define or dynamically define processing parameters for performing a principal task and various subtasks thereof. In particular, processors at one or more of the nodes 32, 34, 36 and 38 include an executable program module to implement the process steps set forth in FIG. 1 to enable a task manager and user-employees of the enterprise to interact with the system 30. Network 54 may comprise wired or wireless links with the nodes, e.g., via a LAN, WAN, WiFi, Internet, or other communication protocol using conventional interfaces and communication standards.

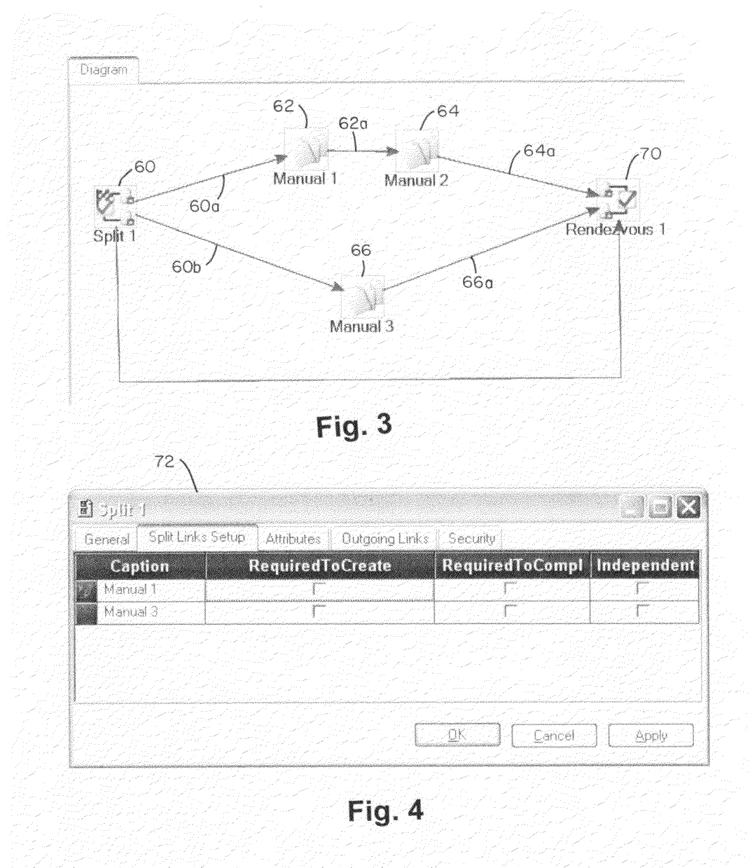

To illustrate steps carried out in system 30 of FIG. 2 by an executable program module implementing the steps shown in FIG. 1, FIG. 3 shows a split step 60 where the task manager identifies a principal task with the aid of an exemplary graphical user interface 72 of FIG. 4. Using the interface 72, the task manager segments the principal task into multiple subtasks 62, 64, and 66 according to his or her knowledge of workflow operations of the business enterprise. The task manager and/or the system 30, at a rendezvous step 70, may assemble or combine the results of the subtasks in order to complete the principal task. Arrows 60a, 60b, 62a, 64a, and 66a that connect steps 60 and 70 denote workflow paths, or links. Split step 60 may be directly linked to any number of other steps, each representing a separate path in the workflow that a subtask takes once created. As indicated above, these designations and/or other steps described herein may be dynamically altered during workflow processing according to changes in business circumstances.

Interface 72 of FIG. 4 respectively identifies subtasks 62 and 66 (FIG. 3) as “Manual 1” and “Manual 2,” which are manually performed by a user to whom the subtask had been assigned. The graphical user interface of FIG. 4 may be generated and presented to a workflow administrator or task manger situated at one of the nodes 10, 20, 30, and 40 (FIG. 1) in order to define a subtask. The executable program module implementing the method of FIG. 1 and installed in the system of FIG. 2 may be configured so that the completed task is automatically moved out of rendezvous step 14 into any following workflow step of the document management system when the last remaining subtask is completed.

When implemented in workflow of a document management system 30 (FIG. 2), the split-rendezvous steps 60, 70 (FIG. 3) entail splitting a primary task obtained from system 30 (FIG. 2) into multiple subtasks, monitoring and reporting the progress of the resulting subtasks throughout their life cycle until their completion, and the combining the subtask results at rendezvous step 70. A subtask is deemed completed when it reaches an End step of a workflow or the Rendezvous step 70, or if it is explicitly terminated by a user or task manager.

A principal task obtained at split step 60, for example, may be split or segmented into as many subtasks as there are outgoing links from the step 60, as determined by a workflow administrator or task manager. For reporting or monitoring purposes, the resulting subtasks may inherit the names of the links that connect the split step 60 to succeeding steps.

The executable split-rendezvous module embodying the invention allows a task manager to specify whether any of the resulting subtasks are required to be created, as well as whether they are required to be completed before the original or preceding task can continue on its workflow path, or whether they are created as entirely independent tasks. A subtask is called a parallel task if it is created as an independent subtask.

When incorporated into workflows, the split-rendezvous module actually allows a workflow administrator to distribute the workload by splitting a task into parallel/serial subtasks and assigning them to other users. This is achieved by simply releasing the task from split step 60. At this point the user may decide (if this right was delegated by the workflow administrator) (i) whether some or all of the subtasks needs to be created, (ii) whether the original task should not continue on its path through the workflow until its subtasks are completed, (iii) whether the subtasks are to be created as independent tasks, or (iv) whether any of the steps, designations, or parameters should be changed, altered, or modified. Upon its release from the split step 60, the original task is moved to rendezvous step 70 of the module and then the subtasks are created. The subtasks can now be assigned to other users or groups of users and will appear in their To Do Lists. The original or principal task will remain in the rendezvous step 14 until all of its required subtasks, if any, are completed. At any point in time, the user can check the current status of completion of all the subtasks. Also, the task manager may change, alter, or modify aspects of the work flow processing. Upon completion of all of the required subtasks, the user or the automated system itself may release the original task into the next step of the workflow. This sequence of processing steps may be repeated for a succession or primary tasks.

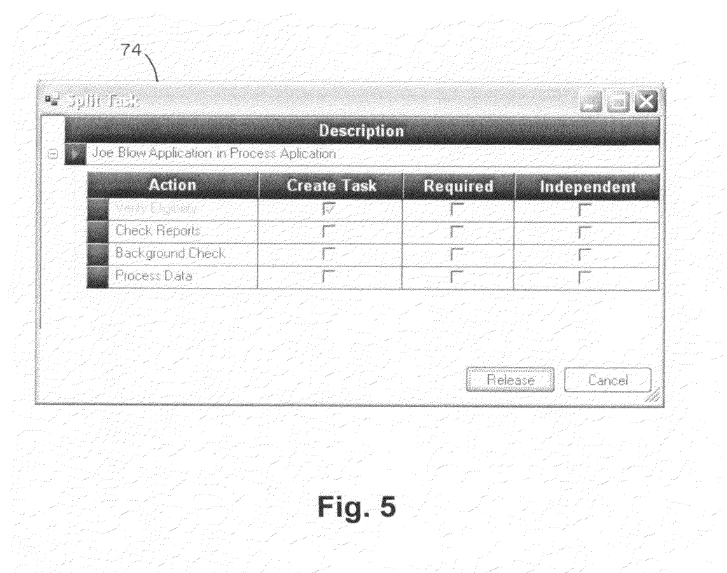

FIG. 5 shows an exemplary user interface 74 presented to a user to identify various subtasks to be performed, i.e., a “To Do List.” Work items in the illustrated “To Do List” include checking reports, performing background check, and processing data. The user releases the split subtask shown in user interface window 74 upon completion of the indicated work items.

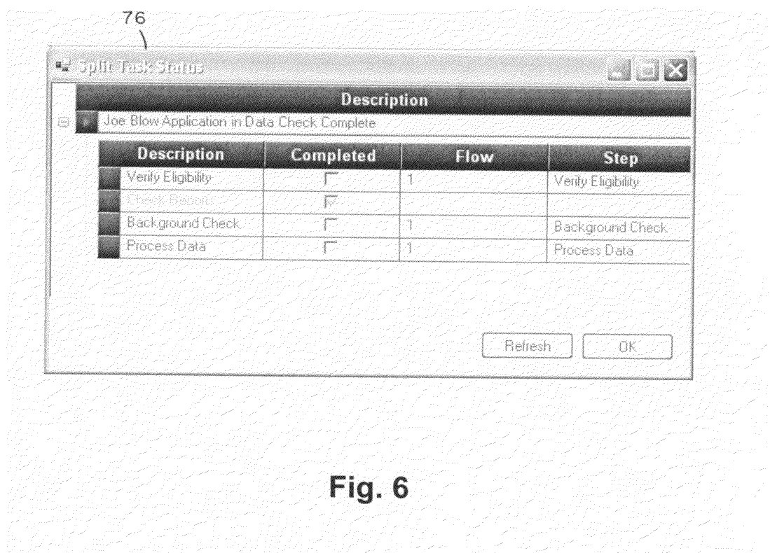

FIG. 6 depicts a status window 76 generated by the executable module and may be called up by a user or the task manager using any one of the display terminals of the file system 30. Window 76 provides a listing of various subtasks, e.g., “Verify Eligibility,” “Check Reports,” “Background Check,” and “Process Data,” along with an indication of their completion status and position in the workflow process. In the exemplary display window, the subtask “Check Reports” is denoted as completed while the remaining subtasks remain in a first stage of their processing, which is denoted by “1” in the “Flow” column.

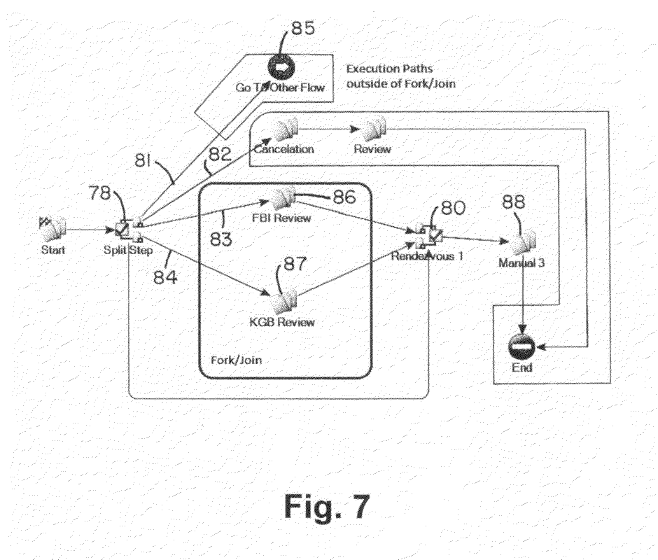

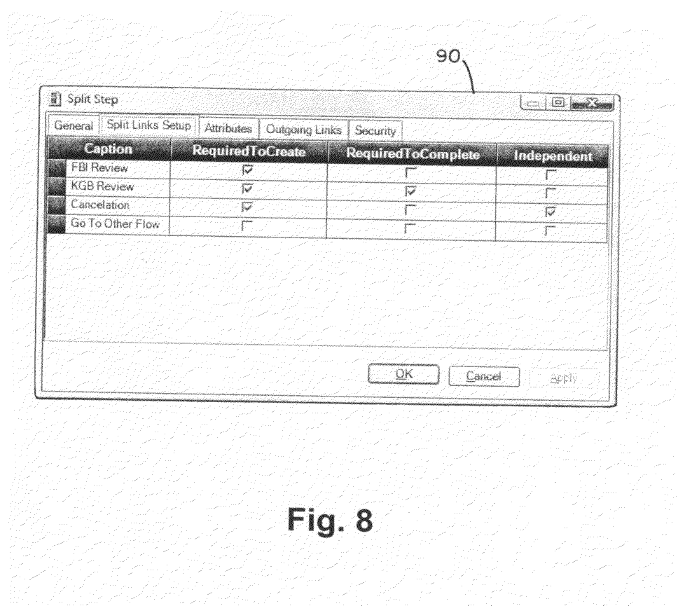

FIG. 7 shows an example of a workflow with split/rendezvous step pair in which the task manager graphically defines an execution path that goes outside of Split/Rendezvous pair 78, 80. This differs from conventional workflow split-join concepts in that, during design of automated workflow processing, the split step 78 allows the task manager to graphically define via a user interface 90 (FIG. 8) an execution path 81 or 82. The split step 78 does not impose any limitations on other predefined “sub-tasks” execution paths 83, 84 which have been predefined as review subtasks 86, 87. A manual release step 88 may also be defined after rendezvous step 80. Any step type from a workflow step palette may be used, including steps that define a path 81 that moves a task to an external workflow 85, a path 82 to cancel a task or subtask, a path 89 to bypass other subtasks, or any number of other split/rendezvous step pairs. In other implementations of the workflow system all execution paths that originated from a split point must end up in a join point, and graphical workflow design tools of the inventive method or apparatus may strictly govern this requirement. The task manager has control over what tasks may be created and executed independently, unrelated to a parent task, as well as which dependent tasks must be completed in order to complete their parent task.

FIG. 8 shows an example of a workflow designation with a split/rendezvous step pair in which a user interface 90 is provided to enable a task manager to define subtasks. In the illustrated example, the task manager forces a future user of the workflow system to undergo three subtasks (FBI Review, KGB Review, and Cancellation) upon releasing the main task from the split step 78 (FIG. 7). Two subtasks, “FBI Review” and “KGB Review,” will obey a well-known fork/join rule. Only one task, “KGB Review,” is required to be completed in order to complete the parent task. The “Cancellation” task is created as an independent task and will thus have its own, completely separate lifecycle. Another subtask, “Go To Other Flow” is optional; however, if created, its lifecycle will depend on that of the parent task.

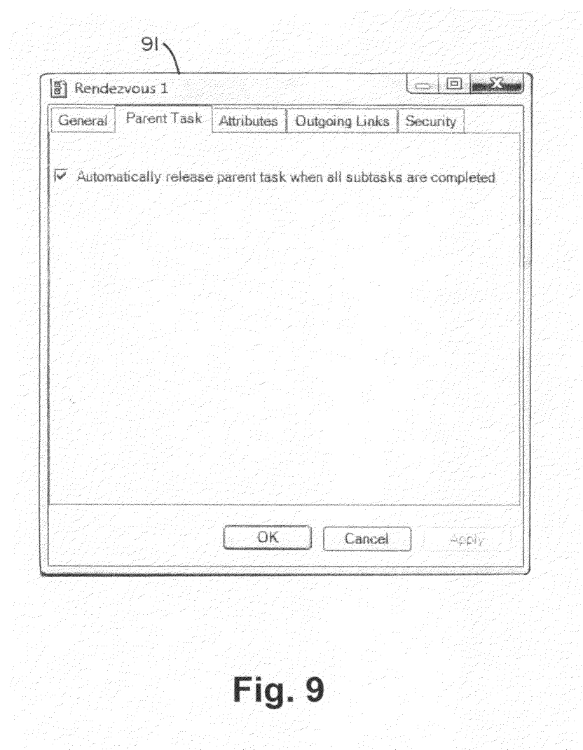

FIG. 9 shows a user interface 92 that is produced by the inventive system to enable the task manager also via a checkbox to automatically release the result upon completion of underlying subtasks. In this situation, for example, a manual release and/or review becomes unnecessary in order to move forward with processing of the completed subtasks. The rendezvous step 80 (FIG. 7) may be configured as “automatic,” in which case a parent task will be released from rendezvous step 80 as soon as the “required” subtasks are completed. All subtasks originated from a Split Step will be routed to the corresponding Rendezvous step upon completion. The Workflow Execution engine of system 30 keeps track of all subtasks created in the Split Step and ensures their transition to the appropriate Rendezvous step regardless of their execution paths. When the parent task leaves the Rendezvous Step through an automatic or manual release action, Workflow Runtime kills any optional sub-tasks that were created in the Split step. Further, Workflow Runtime maintains separate lifecycle for all “Independent” tasks created in the Split Step.

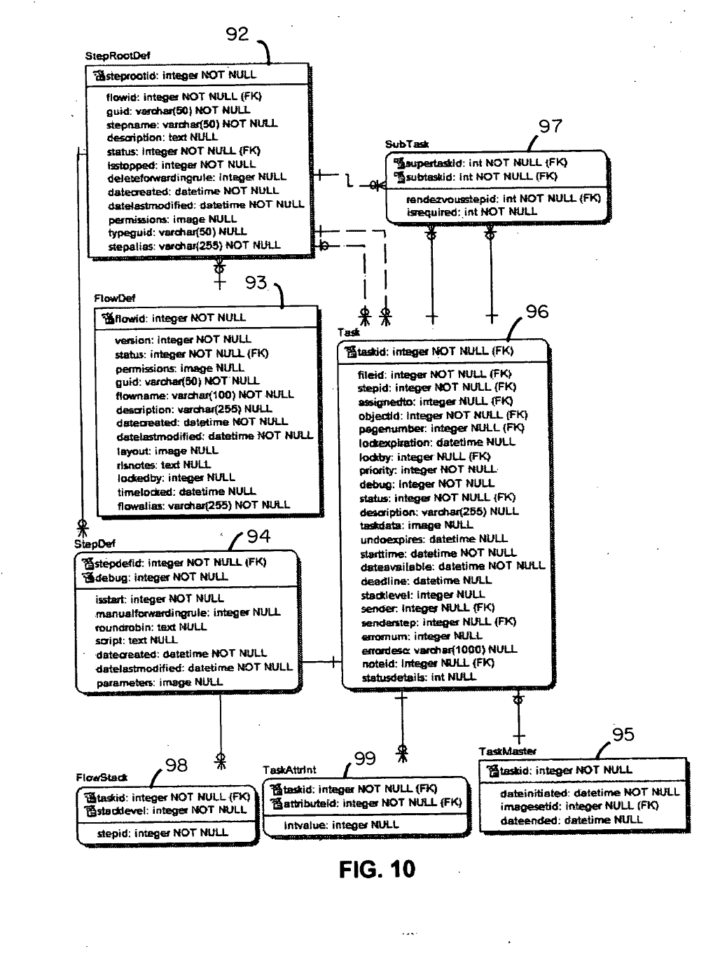

FIG. 10 shows an example of workflow and tasks-related database schema that may be utilized by the inventive systems and methods illustrated herein, in which FlowDef 93 defines a Design-time Workflow Definition; StepRootDef 92 defines a Design-time Step Definition; StepDef 94 defines a second part of the Design-time Step definition; TaskMaster 95 defines a Master Task record; Task 96 defines a Task Record that contains all data related to the task execution; SubTask 97 defines a Link record that governs relations between Parent task, sub-tasks and rendezvous step; FlowStack 98 defines Tracks “Call” to other Workflow and Rendezvous steps; and TaskAttributes 99 defines a Runtime task variables.

While the invention is illustrated by way of exemplary embodiments and illustrations, variations may come to those skilled in the art without departing from the invention defined by the appended claims. Accordingly, neither the written description nor the drawings are intended to limit the scope of the invention.

We claim:

1. In a file management system having user processing points at multiple locations of a communication network of a business enterprise, a method of automating workflow operations via interaction between a task manager and the file management system comprising the steps of:
identifying via a graphical interface a principal task in the workflow operations of the enterprise;
enabling the task manager to split the principal task into two or more subtasks according to knowledge of the workflow operations;
enabling the task manager to provide names for the subtasks;
specifying an order of completion of the subtasks according to an interrelation therebetween;
according to provided names, assigning the subtasks to one or more users in the business enterprise;
sending over the network notification to said users of subtask assignment;
enabling the users to denote completion of an assigned subtask and monitoring status of completion thereof;
providing an indication of said status of completion,
denoting completion of said principal task upon completion of subtasks thereof; and
enabling the task manager to alter, change or modify any one or more of the preceding steps during workflow operations.

2. The method according to claim 1 wherein the step of enabling the task manager to split the principal task comprises:
determining which if any subtasks are to be created according to knowledge of the business enterprise, and
determining which of the created subtasks are to be parallel-processed and which are to be serially-processed according to any interrelation therebetween.

3. The method according to claim 2, further comprising, after said denoting step, releasing the principal task for further processing in a workflow process of other tasks.

4. The method according to claim 4, further comprising automatically reporting to said task manager an indication of completion of the subtasks.

5. The method of claim 1, further comprising designating a user as a task manager to interact with the file management system to process a principal task.

6. In a file management system, a method of facilitating workflow processing comprising the steps of:
identifying a principal task in a workflow process,
splitting the principal task into two or more subtasks according actual practices of the business enterprise, said splitting includes determining which if any subtasks are to be create and which of the created subtasks are to be parallel-processed and which of the subtasks are to be serially-processed,
naming the subtasks,
specifying an order of completion of the subtasks as parallel-processed or serially-processed,
assigning the subtasks to one or more users for processing,
notifying said users of assignment of said subtasks,
providing an indication of status of completion of the subtasks,
reporting the completion of the subtasks to said task manager,
completing said principal task according to results of said subtasks,
enabling a user to check status of subtasks, and
releasing the principal task in a workflow of other tasks.

7. In a file management system having user workstations communicating over a network, an improvement to automate workflow operations of a business enterprise via interaction between a task manager and the file management system comprising:
a first graphical user interface generated at a workstation to enable the task manager to identify a principal task in the workflow operations of the enterprise, to split the principal task into two or more subtasks according to knowledge of the workflow operations, to provide names for the subtasks, to specify an order of performance of the subtasks according to an interrelation therebetween, and to assign the subtasks to one or more users within the business enterprise;
a communication interface responsive to information provided via said first graphical user interface to convey a message over the network to notify said users of subtask assignment;
a second graphical user interface generated at a second workstation to enable a user to receive notification of said task assignment, to denote completion of an assigned subtask, and to convey a status message indicating progress of completion of a subtask; and
a task management module of said file management system to receive said status message from said user, to provide upon inquiry an indication status of completion of said subtask, and to denote completion of said principal task upon completion of all subtasks thereof.

8. The improvement of claim 7, wherein said first user interface enables the task manager to specify a serial order of completion of a subtask when completion thereof depends on completion another subtask and to specify a parallel order when completion of a subtask does not depend on results of another subtask.

9. The improvement of claim 8, wherein said first user interface enables a workflow administrator to delegate a user as a task manager.

10. The improvement of claim 7, wherein the first graphical user interface enables the task manager to alter, change or modify any one or more of identifying, splitting, specifying and assigning enabled by said first graphical user interface during automated workflow processing.
